(19) United States
(12) Patent Application Publication
(10) Pub. No.: US 2023/0033709 A1
(43) Pub. Date: Feb. 2, 2023

(54) Movable Wall Storage Device

(71) Applicant: Howard Vaughan, Cofield, NC (US)

(72) Inventor: Howard Vaughan, Cofield, NC (US)

(21) Appl. No.: 17/876,887

(22) Filed: Jul. 29, 2022

Related U.S. Application Data
(60) Provisional application No. 63/226,844, filed on Jul. 29, 2021.

(51) Int. Cl. E04B 2/82; E04H 1/12; E06B 3/46; E06B 3/36

(52) U.S. Cl. CPC E04B 2/827; E04H 1/1205; E06B 3/4636; E06B 3/36

(57) ABSTRACT

The present invention relates to a movable wall storage device comprised of a front wall, a rear wall, a first side wall, a second side wall, a floor and a roof. The bottom edges of the roof are further comprised of a track that receives a roller located on the top edges of the first and second side walls. In this manner, the side walls can be slid along the track to expose the interior surface of the device. The device may also be comprised of a movable sub-floor that slides outwards from the interior space. Both the sub-floor and the sidewalls allow a user to easily place or remove large items into the interior space of the device, without having to step into the interior space or struggle to move the item through a door or other similar structure.

### CROSS-REFERENCE TO RELATED APPLICATION

The present application claims priority to, and the benefit of, U.S. Provisional Application No. 63/226,844, which was filed on Jul. 29, 2021 and is incorporated herein by reference in its entirety.

### FIELD OF THE INVENTION

The present invention relates generally to the field of storage structures. More specifically, the present invention relates to a movable wall storage device comprised of a front wall, a rear wall, a first side wall, a second side wall, a floor and a roof. The bottom edges of the roof are further comprised of a track that receives a roller located on the top edges of the first and second side walls. In this manner, the side walls can be slid along the track to expose the interior surface of the device. Accordingly, the present disclosure makes specific reference thereto. Nonetheless, it is to be appreciated that aspects of the present invention are also equally applicable to other like applications, devices and methods of manufacture.

### BACKGROUND

Sheds are often used in an outdoor setting to store vehicles, tools and other property. Because a shed is a walled structure, the contents of the shed are not exposed to precipitation, UV rays, other outdoor conditions or the possibility of theft. Sheds and other similar structures are also frequently used to store large items that cannot be easily stored within an attic, a basement, or a garage. However, sheds or other similar structures typically only have one to two doors at the front of the structure. These doors may further be too small to allow an extremely large, tall, wide, and/or obscurely shaped item to easily fit through the doors, and thus be stored into the shed. This is obviously undesirable, as it prevents the item from being stored within the shed. Further, many individuals store a plurality of items within a shed or other similar structure, such that certain items may not be able to be accessed without removing or moving other nearby items within the shed. This is undesirable, as it is time-consuming and an unnecessary waste of effort.

Therefore, there exists a long-felt need in the art for a shed-type structure that allows a user to easily store large items within the structure. There also exists a long-felt need in the art for a movable wall storage device that allows a user to easily move large items into the interior space of the device, by temporally removing or repositioning the walls of the device. Further, there exists a long-felt need in the art for a movable wall storage device that allows a user to remove items stored within the device, by temporally removing or moving the walls of the device and also while not disturbing other nearby items within the interior space to do so.

The subject matter disclosed and claimed herein, in one embodiment thereof, comprises a movable wall storage device. The device is comprised of a front wall, a rear wall, a first side wall, a second side wall, a floor and a roof. The bottom edges of the roof are further comprised of a track that receives a roller located on the top edges of the first and second side walls. In this manner, the side walls can be slid along the track, to expose the interior surface of the device. The device may also be comprised of a movable sub-floor that slides outwards from the interior space. Both the sub-floor and the sidewalls allow a user to easily place or remove large items into the interior space of the device, without having to step into the interior space or struggle to move the item through a door or other similar structure.

In this manner, the movable wall storage device of the present invention accomplishes all of the forgoing objectives and provides an improved shed-type device. The device allows a user to easily store large items within the structure in a manner not possible with existing devices of the like, wherein a user can easily remove or place large items within the interior space of the device, without having to move other items within the device or without having to fit the items through a small door. In addition, the device allows a user to retrieve items, without having to physically enter the interior space. In this manner, the movable wall storage device overcomes the limitations of existing shed-type devices known in the art.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a movable wall storage device. The device is primarily comprised of a front wall, a rear wall, a first side wall, a second side wall, a floor and a roof. In differing embodiments, any wall may be further comprised of at least one door and at least one window. The walls and roof may be arranged in any conventional, structural shape such as, but not limited to, generally square, generally rectangular, polygonal, etc. The roof may also be a pitched roof or a flat roof. Further, the walls, floor and roof are preferably connected to each other via removable fasteners such as, but not limited to, screws, bolts, welds, etc.

Furthermore, the roof has a first bottom edge and a second bottom edge that contact the top edge of the first side wall and the top edge of the second side wall. The bottom edges are further comprised of a generally U-shaped track that receives and captures at least one roller/wheel located on the top edge of each side wall. In this manner, the walls can be slid along the track via the roller, such that the walls can slide past the front wall and/or rear wall to expose the interior space of the device. Therefore, one or both walls can be slid, such that a user can easily remove or place a large item within the interior space without having to move the item into the interior space through the door. In another alternative embodiment, the walls have no rollers and the roof has no track, but the device is comprised of at least one hinge on at least one side edge of each wall. The at least one hinge attaches to each wall as well as to the front wall and/or rear wall to allow both walls to pivot about the hinge to open and expose the interior space.

The floor may also be comprised of an additional sub-floor, wherein the top surface of the floor has at least one (but preferably two) tracks which receive at least one roller located on the bottom surface of the sub-floor. The sub-floor can then be slid outwards from the interior space of the device in the directions of each wall, after each wall has been slid out of position past the front wall and/or rear wall. As a result, a user need not even physically enter the interior space to retrieve an item located on the sub-floor. Alternatively, the center of the sub-floor may have at least one pivot point, which is fixedly-attached to the sub-floor and the top surface of the floor and allows the sub-floor to spin in a 360-degree range of motion above the floor.

Accordingly, the movable wall storage device of the present invention is particularly advantageous as it allows a user to easily store large items within the structure in a manner not possible with existing devices of the like. In this regard, a user can easily remove or place large items within the device, without having to move other items within the device or without having to fit the items through a small door. Further, the device allows a user to retrieve items without having to physically enter the interior space. In this manner, the movable wall storage device overcomes the limitations of existing shed-type devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the movable wall storage device of the present invention in accordance with the disclosed architecture;

FIG. 2 illustrates an enhanced perspective view of one potential embodiment of a track and a roller of the movable wall storage device of the present invention in accordance with the disclosed architecture;

FIG. 3 illustrates a perspective view of one potential embodiment of the movable wall storage device of the present invention, wherein the wall pivots about the hinge in accordance with the disclosed architecture;

FIG. 4 illustrates a perspective view of one potential embodiment of the movable wall storage device of the present invention, wherein the wall pivots upwards toward the roof in accordance with the disclosed architecture; and

FIG. 5 illustrates a perspective view of one potential embodiment of the movable wall storage device of the present invention, wherein the subfloor is extended in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a shed-type structure that allows a user to easily store large items within the structure. There also exists a long-felt need in the art for a movable wall storage device, that allows a user to easily move large items into the interior space of the device, by temporally removing the walls of the device. Further, there exists a long-felt need in the art for a movable wall storage device, that allows a user to remove items stored within the interior space by temporally removing the walls of the device and also while not disturbing other nearby items.

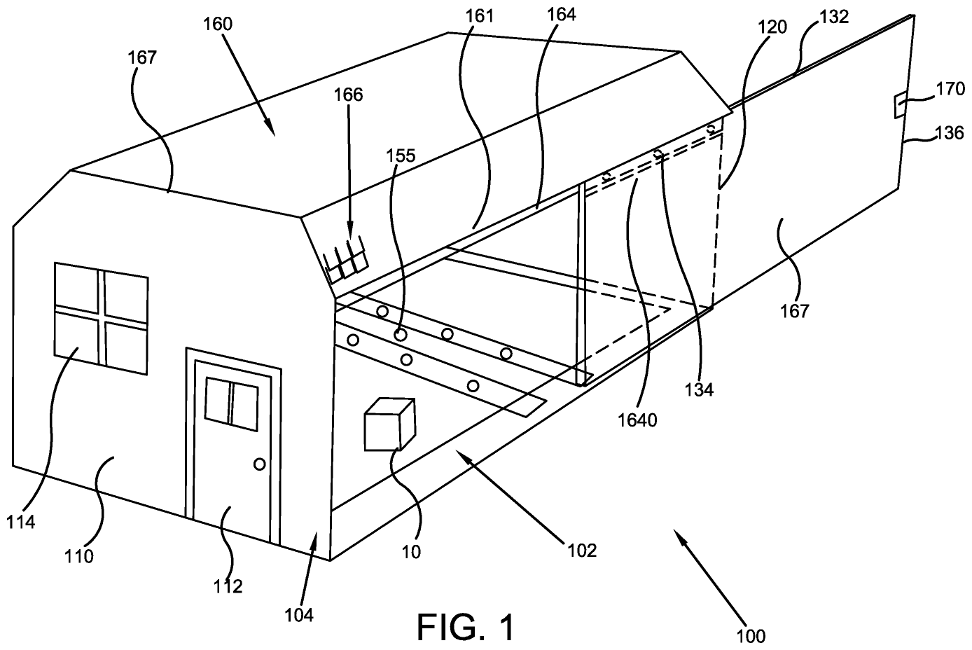

Referring initially to the drawings, FIG. 1 illustrates a perspective view of one embodiment of the movable wall storage device 100 of the present invention. The device 100 is primarily comprised of a front wall 110, a rear wall 120, a first side wall 130, a second side wall 140, a floor 150 and a roof 160. The walls 110, 120, 130, 140 are preferably manufactured from a wood and/or durable metal, etc., or any other suitable material as is known in the art. The roof 160 may also be manufactured from a wood and/or durable metal material, etc., or any other suitable material as is known in the art and may have a plurality of asphalt or metal shingles 166.

In differing embodiments, any wall 110, 120, 130, 140 may be further comprised of at least one door 112 and at least one window 114, or any other suitable number of doors and/or walls as is known in the art. In one embodiment, the door 112 can be lifted or rolled upwards to grant access to the interior space 102. However, in one embodiment of the device 100, there may not be any windows 114 in the walls 110, 120, 130, 140. In differing embodiments, the walls 110, 120, 130, 140 and roof 160 may be arranged in any conventional, structural shape, such as but not limited to: generally square, generally rectangular, polygonal, etc., or any other suitable shape as is known in the art. The roof 160 may also be a pitched roof or a flat roof, etc. Further, the walls 110, 120, 130, 140, floor 150, and roof 160 are preferably connected to each other via removable fasteners, such as, but not limited to, screws, bolts, welds, etc., or any other suitable fasteners as are known in the art.

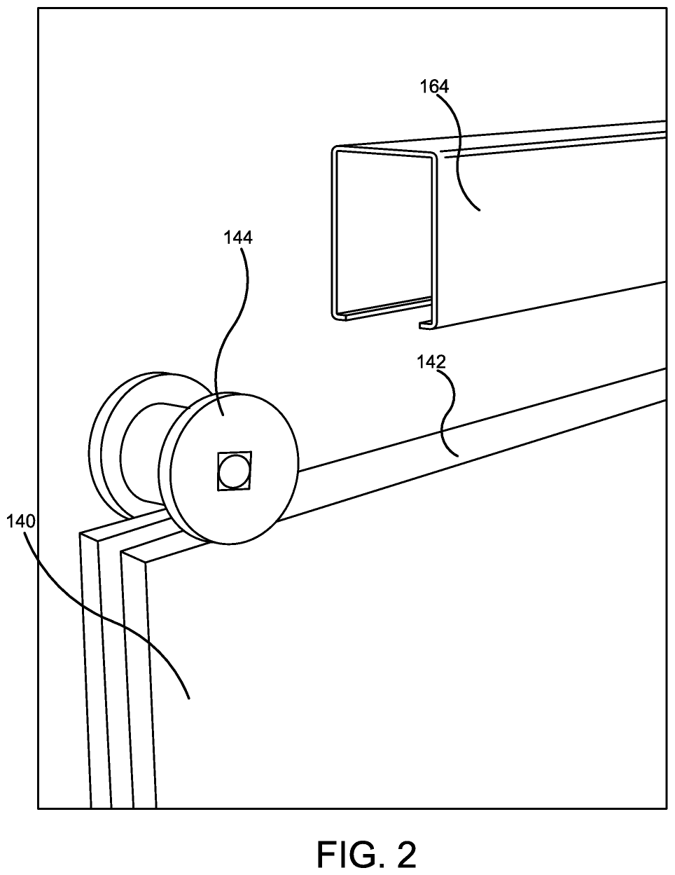

The roof 160 is further comprised of a first bottom edge 161 and a second bottom edge 162 that contact the top edges 132, 142 of the first side wall 130 and the second side wall 140. The bottom edges 161, 162 are further comprised of a generally upside-down U-shaped track 164, that is preferably manufactured from a durable metal material or any other suitable material as is known in the art. The top edge 132, 142 of each side wall 130, 140 is further comprised of at least one roller/wheel 134, 144 that is captured within the track 164 of each bottom edge 161, 162, as best seen in FIG. 2. In this manner, the walls 130, 140 can be slid along the track 164 via the roller 134, 144, such that the walls 130, 140 can slide past the front wall 110 and/or the rear wall 120 to expose the interior space 102 of the device 100. As a result, one or both walls 130, 140 can be slid, such that a user can easily remove or place a large item 10 within the interior space 102, without having to move the item 10 into the space 102 through the door 112. In addition, a user can slide one or both walls 130, 140 to access items 10 positioned near the walls 130, 140 that may be blocked by other items 10 within the space 102 and which would typically render said items 10 inaccessible in an existing shed known in the art.

In differing embodiments, the front wall 110 and/or rear wall 120 may also be comprised of at least one roller 134, 144 and the front bottom edge 167 and rear bottom edge 168 of the roof 160 may also be comprised of a track 164. In this manner, the front wall 110 and the rear wall 120 can be slid along the tracks 164 in the same manner as the other walls 130, 140 in an embodiment, wherein the other walls 130, 140 are fixed and immovable. In any embodiment, the device 100 is preferably comprised of at least one wall 110, 120, 130, 140 that has at least one roller 134, 144 and is received by a track 164 of at least one edge 161, 162, 167, 168 of the roof 160.

In order to secure the walls 110, 120, 130, 140 when motion of the walls 110, 120, 130, 140 is not desired, each wall 110, 120, 130, 140 is comprised of at least one lock 170, that allows one wall 110, 120, 130, 140 to be attached to another wall 110, 120, 130, 140. In this manner, any wall 110, 120, 130, 140 with at least one roller 134, 144 is prevented from moving when not desired. In differing embodiments, the at least one lock 170 may be any suitable lock or latch type as is known in the art. Further, the lock 170 may be located within the interior space 102 and or on the exterior surface 104 of the walls 110, 120, 130, 140 to allow the walls 110, 120, 130, 140 to be locked or unlocked from inside or outside of the device 100. Typically, the lock 170 is positioned on a side edge 136 of the first side wall 130, but can be positioned in any suitable place as is known in the art.

In order to ensure that no precipitation or outdoor conditions penetrate the device 100 and enter the interior space 102, any track 164 of the device 100 is further comprised of a weatherproof, rubber seal 1640. The seal 1640 encloses the track 164 and/or the rollers 134, 144, such that no gaps are present on the exterior of the device 100. However, the seal 1640 does not inhibit the movement of the rollers 134, 144.

As shown in FIG. 2, the roof 160 comprises a second bottom edge 162 that contacts the top edge 142 of the second side wall 140. The bottom edge 162 comprises a generally upside-down U-shaped metal track 164. The top edge 142 of the second side wall 140 comprises at least one roller/wheel 144 that is captured within the track 164. In this manner, the second side wall 140 can be slid along the track 164 via the roller 144, such that the second side wall 140 can slide past the front wall 110 to expose the interior space 102 of the device 100. As a result, the second side wall 140 can be slid, such that a user can easily remove or place a large item 10 within the interior space 102, without having to move the item 10 into the space 102 through the door 112.

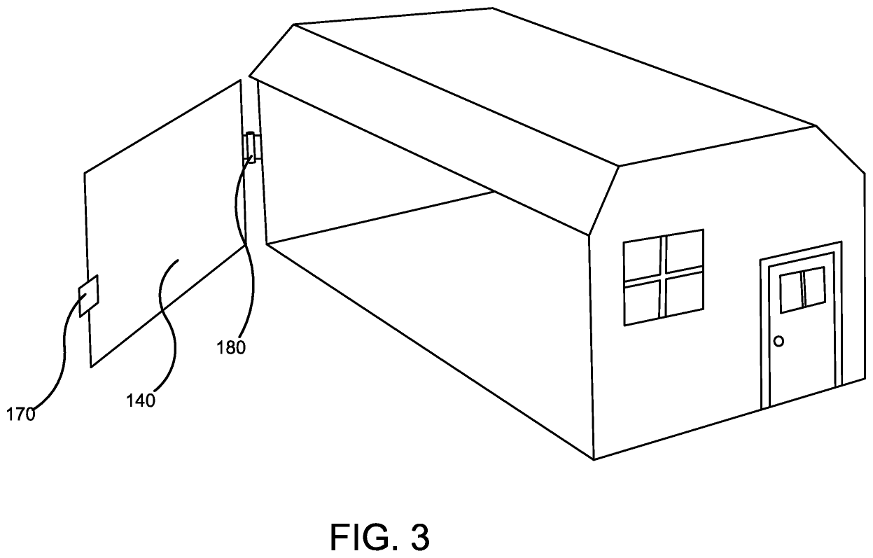

As shown in FIG. 3, the walls have no rollers 134, 144 and the roof 160 has no track 164. Instead, at least one side edge 136, 146 of each wall 130, 140 is comprised of at least one hinge 180. The at least one hinge 180 attaches to each wall 130, 140, as well as to the front wall 110 and/or the rear wall 120. In this manner, both walls 130, 140 can pivot about the hinge 180 from the rear wall 120 and/or the front wall 110. The hinge 180 further locks, such that a user can lock the walls 130, 140 in a specific position. Further, each wall 110, 120, 130, 140 is comprised of at least one lock 170, that allows one wall 110, 120, 130, 140 to be attached to another wall 110, 120, 130, 140 and secured in place via the lock 170.

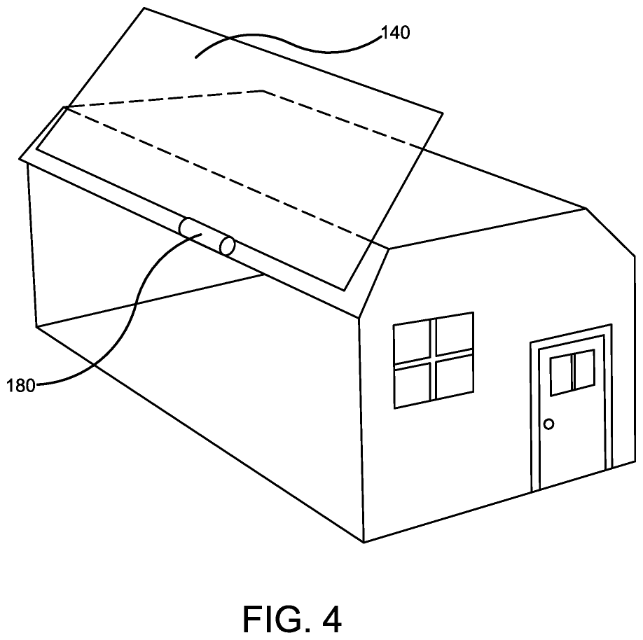

As shown in FIG. 4, any or all walls 110, 120, 130, 140 and/or the roof 160 may have at least one hinge 180, which allows the walls 110, 120, 130, 140 to pivot around the rear wall 120 and front wall 110 and/or pivot around the bottom edges 161, 162, 167, 168 of the roof 160, (i.e., wherein the walls 110, 120, 130, 140 pivot upwards towards the roof 160).

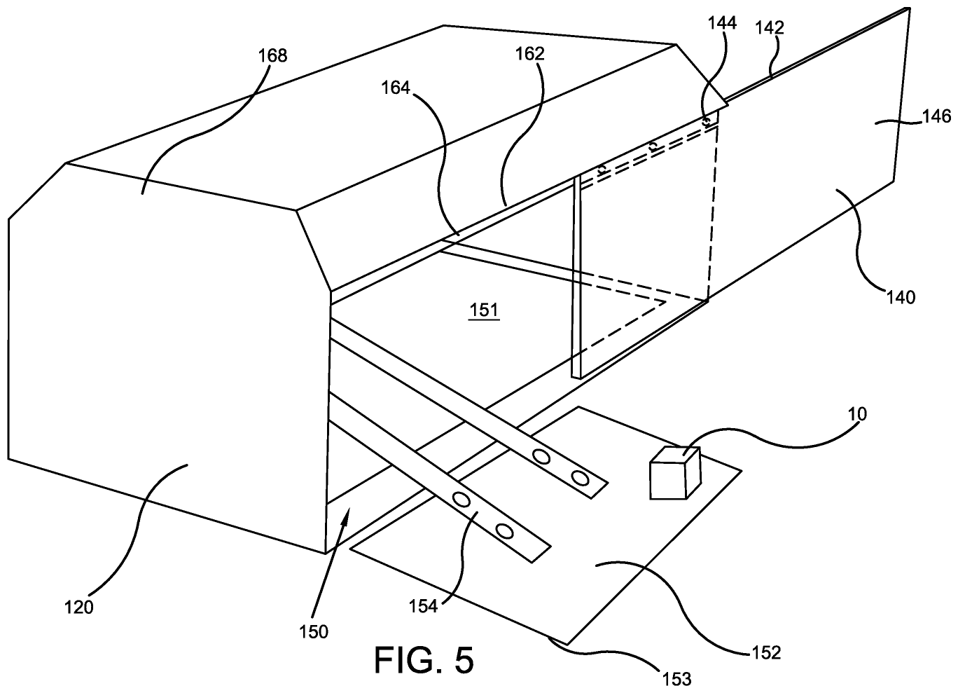

FIG. 5 illustrates a perspective view of one embodiment of the movable wall storage device 100 of the present invention. In a further embodiment, the floor 150 may be comprised of an additional sub-floor 152. The sub-floor 152 may be generally square, rectangular, polygonal, circular, etc., or any other suitable surface as is known in the art. The top surface 151 of the floor 150 is further comprised of at least one but preferably two tracks 164, which receive at least one roller 154 located on the bottom surface 153 of the sub-floor 152. In this manner, the sub-floor 152 can be slid outwards from the interior space 102 in the directions of each wall 130, 140. However it should be appreciated that this process can occur only after each wall 130, 140 has been slid out of position past the front wall 110 and/or rear wall 120. Therefore, a user need not even physically enter the interior space 102 to retrieve an item 10 located on the sub-floor 152.

Alternatively, the center of the sub-floor 152 may have at least one pivot point 155 (shown in FIG. 1) which is fixedly attached to the sub-floor 152 and the top surface 151 of the floor 150. As such, the sub-floor 152 is smaller in size than the floor 150 and typically circular in shape to allow the sub-floor 152 to spin in a 360-degree range of motion above the floor 150. This allows a user to be able to stand where one and/or each wall 130, 140 would be, after each wall 130, 140 has been slid out of position past the front wall 110 and/or rear wall 120, and rotate the sub-floor 152 as needed, until the item 10 they wish to receive is present in front of them.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “movable wall storage device” and “device” are interchangeable and refer to the movable wall storage device 100 of the present invention.

Notwithstanding the forgoing, the movable wall storage device 100 of the present invention and its various components can be of any suitable size and configuration as is known in the art without affecting the overall concept of the invention, provided that they accomplish the above-stated objectives. One of ordinary skill in the art will appreciate that the size, configuration and material of the movable wall storage device 100 as shown in FIGS. 1-5 is for illustrative purposes only, and that many other sizes and shapes of the movable wall storage device 100 are well within the scope of the present disclosure. Although the dimensions of the movable wall storage device 100 are important design parameters for user convenience, the movable wall storage device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A movable wall storage device comprising:
a front wall;
a rear wall;
a roof, wherein a first bottom edge and a second bottom edge of the roof are comprised of a track;
a first side wall, wherein a top edge of the first side wall is comprised of at least one roller that is received by the track of the first bottom edge of the roof;
a second side wall, wherein a top edge of the second side wall is comprised of at least one roller that is received by the track of the second bottom edge of the roof;
a floor; and
an interior space formed by the front wall, the rear wall, the first side wall, the second side wall, the floor and the roof.

2. The movable wall storage device of claim 1, wherein the first side wall and the second side wall are slid using the track of the first bottom edge and the track of the second bottom edge of the roof to reveal the interior space.

3. The movable wall storage device of claim 2, wherein the first side wall and the second side wall slide past the front wall or the rear wall.

4. A movable wall storage device comprising:
a front wall;
a rear wall;
a roof, wherein a first bottom edge and a second bottom edge of the roof are comprised of a track;
at least one door;
a first side wall, wherein a side edge of the first side wall is further comprised of at least one hinge;
a second side wall, wherein a side edge of the second side wall is further comprised of at least one hinge;
a floor;
a sub-floor; and
an interior space formed by the front wall, the rear wall, the first side wall, the second side wall, the floor and the roof.

5. The movable wall storage device of claim 4, wherein the at least one hinge of the first side wall and the at least one hinge of the second side wall are attached to the rear wall, the front wall or the roof.

6. The movable wall storage device of claim 5, wherein the first side wall and the second side wall can pivot about the at least one hinge.

7. The movable wall storage device of claim 4, wherein the at least one hinge is attached to the front wall, the rear wall, the first side wall, the second side wall or the roof.

8. A movable wall storage device comprising:
a front wall;
a rear wall;
a roof, wherein a first bottom edge and a second bottom edge of the roof are comprised of a track;
at least one door;
a first side wall, wherein a top edge of the first side wall is comprised of at least one roller that is received by the track of the first bottom edge of the roof;
a second side wall, wherein a top edge of the second side wall is comprised of at least one roller that is received by the track of the second bottom edge of the roof;
a floor, wherein a top surface of the floor is comprised of at least one U-shaped track;
at least one rubber seal;
at least one lock;
a sub-floor, wherein a bottom surface of the sub-floor is comprised of at least one roller; and
an interior space formed by the front wall, the rear wall, the first side wall, the second side wall, the floor and the roof.

9. The movable wall storage device of claim 8, wherein the first side wall and the second side wall are slid using the track of the first bottom edge and the track of the second bottom edge of the roof to reveal the interior space.

10. The movable wall storage device of claim 9, wherein the first side wall and the second side wall slide past the front wall or the rear wall.

11. The movable wall storage device of claim 8, wherein the track of the first bottom edge of the roof and the track of the second bottom edge of the roof is an upside-down U-shaped track.

12. The movable wall storage device of claim 8, wherein the at least one rubber seal encloses the track of the first bottom edge of the roof and the track of the second bottom edge of the roof, as well as the at least one roller of the first side wall and the at least one roller of the second side wall to prevent precipitation from entering into the interior space.

13. The movable wall storage device of claim 8, wherein the at least one lock allows a user to secure the first sidewall or the second side wall in an immovable position.

14. The movable wall storage device of claim 13, wherein the at least one lock is located within the interior space or on an exterior surface of the front wall, the rear wall, the first side wall, or the second side wall.

15. The movable wall storage device of claim 8, wherein the at least one roller of the sub-floor engages the at least one track of the floor.

16. The movable wall storage device of claim 15, wherein the sub-floor can be slid outwards from the interior space via the at least one roller and the at least one track.

17. The movable wall storage device of claim 16, wherein a user need not physically enter the interior space to retrieve an item located on the sub-floor.

18. The movable wall storage device of claim 8, wherein the sub-floor is comprised of a pivot point.

19. The movable wall storage device of claim 18, wherein the pivot point allows the sub-floor to spin in a 360-degree range of motion above the floor.

20. The movable wall storage device of claim 8, wherein the front wall, the rear wall, the first side wall, or the second side wall is comprised of at least one window.
